(19) United States
(12) Patent Application Publication
(10) Pub. No.: US 2016/0355389 A1
(43) Pub. Date: Dec. 8, 2016

(54) Keg Management and Monitoring System

(71) Applicants: Christopher Bursey, San Diego, CA (US); Kevin Blakeley, San Diego, CA (US); Eric Placzek, San Diego, CA (US); Rhonda Bass, San Diego, CA (US); David Scowby, San Diego, CA (US)

(72) Inventors: Christopher Bursey, San Diego, CA (US); Kevin Blakeley, San Diego, CA (US); Eric Placzek, San Diego, CA (US); Rhonda Bass, San Diego, CA (US); David Scowby, San Diego, CA (US)

(21) Appl. No.: 15/170,021

(22) Filed: Jun. 1, 2016

Related U.S. Application Data
(60) Provisional application No. 62/170,028, filed on Jun. 2, 2015.

(51) Int. Cl. B67D 1/08; B67D 1/04; B67D 1/00

(52) U.S. Cl. CPC B67D 1/0888; B67D 1/0004; B67D 1/0406; B67D 1/0855; B67D 1/0801; B67D 2001/0822

(57) ABSTRACT

A wireless keg management and monitoring system having a meter, antenna, data hub, thermometer, and pressure sensor, the system capable of measuring a plurality of preprogrammed parameters within a beverage dispensing system. Data collected by the keg management and monitoring system is utilized by a user platform to create alerts for a user when a data point falls outside of a preprogrammed limit.

### RELATED APPLICATIONS

This application is an International Patent Application claiming priority from U.S. Provisional Patent Application No. 62/170,028 filed Jun. 2, 2015.

### FIELD OF INVENTION

The present invention pertains generally to commercial beverage management and monitoring systems. More particularly, the present invention pertains to wireless commercial keg management and monitoring systems.

Beverage management systems are also widely known in the art. Examples in the prior art include the following:

U.S. Pat. No. 5,007,560 issued to Sassak discloses a beer dispensing and monitoring method and apparatus wherein the beer dispensing apparatus delivers beer to a valve that is opened to dispense a predetermined weight of the beverage by monitoring the reduced weight of the supply keg.

U.S. Pat. No. 6,003,542 issued to Pizzacalla et al. discloses an automatic shut-off valve for regulating the flow of beer or other liquid from its container, wherein the valve has an inlet, an outlet and an interior chamber, the chamber having a top and bottom with an opening at the bottom and further wherein a float in the chamber is configured to close the opening when the float reaches the bottom of the chamber.

U.S. Patent Publication No. 2012/0059513 by Perkins et al. discloses a beverage dispensing and monitoring system having a sensor box for measuring attributes of the beverage, wherein the sensor box includes sensors such as a flowmeter, a temperature sensor, a pressure sensor, a humidity sensor, a bioflavonoids sensor, a gas/liquid substance sensor, and further wherein the attributes include flow rate or total flow, temperature, pressure and any other attributes of the beverage that are useful in determining quality.

U.S. Patent Publication No. 2013/0314244 by Hershberger et al. discloses a supply chain system and method for monitoring fluid levels in liquid containers, such as kegs, wherein an apparatus is disclosed, the apparatus including a sensor/transmitter adapted to attach to the container, sensor/transmitter including a liquid quantity sensor configured and adapted to detect the amount of liquid within a container, a receiver that receives information related to the liquid in the container from a wireless electronic communication device, and a transmitter that receives information from the receiver and from the liquid quantity sensor, wherein the transmitter transmits information received from the receiver and the liquid quantity sensor to a wireless network.

In light of the above, it is an object of the present invention to provide the desired features described herein as well as additional advantages of providing a simple and singular commercial keg management and monitoring system capable of providing real time data from several physical locations simultaneously to a user thereby streamlining the draft beer system and increasing profits while reducing keg downtime.

### SUMMARY OF THE INVENTION

The present invention is a keg management and monitoring system. It is an object of the present invention to provide a wireless keg management and monitoring system wherein the system is comprised of at least one meter, a combination wireless antenna and GPS antenna, a thermometer, a data hub, and an on/off valve.

It is another object of the present invention to provide a wireless keg management and monitoring system wherein the meter is further comprised of a flow meter contained within the meter, the meter further having a coupler at one end for connecting to a keg and a coupler at the opposite end for connecting tubing.

It is still another object of the present invention to provide a wireless keg management and monitoring system wherein the meter is capable of providing real time monitoring of the refrigeration temperature, total flow, CO₂ pressure, location and time stamp of at least one keg which is connected to the system.

It is a further object of the present invention to provide a wireless keg management and monitoring system wherein the wireless antennae enables a data hub to communicate real time data analytics via cellular network and provide a GPS signal providing the location of the data hub and meters.

It is another object of the present invention to provide a wireless keg management and monitoring system wherein a data hub is programmable through a user platform thereby providing customizable control of at least one meter and/or on/off valve.

It is yet another object of the present invention to provide a wireless keg management and monitoring system wherein the user platform is compatible with a variety of devices including, but not limited to, computers, iPads, tablets, and smart phones.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar parts, and in which:

FIG. 1 illustrates a diagram of a preferred embodiment of the wireless keg management and monitoring system of the present invention;

FIG. 2 illustrates a first view of the installed wireless keg management and monitoring of the present invention;

FIG. 3 illustrates an alternative view of the installed wireless keg management and monitoring system of the present invention as shown in FIG. 2;

FIG. 4 illustrates an alternative view of the installed wireless keg management and monitoring system of the present invention as shown in FIG. 3;

FIG. 5 illustrates first view of the CO₂ meter coupler of the present invention;

FIG. 6 illustrates an alternative view of the CO2 meter coupler of the present invention as shown in FIG. 5;

FIG. 7 illustrates a first view of the meter of the present invention;

FIG. 8 illustrates an alternative view of the meter of the present invention as shown in FIG. 7;

FIG. 9 illustrates another alternative view of the meter of the present invention as shown in FIG. 7;

FIG. 10 illustrates a schematic view of the functioning of the present invention;

FIG. 11 illustrates the login page of the user platform of the present invention;

FIG. 12 illustrates the home dashboard page of the user platform of the present invention;

FIG. 13 illustrates the keg management page of the user platform of the present invention; and

FIG. 14 illustrates the data entry page of the user platform of the present invention.

### DETAILED DESCRIPTION. OF THE INVENTION

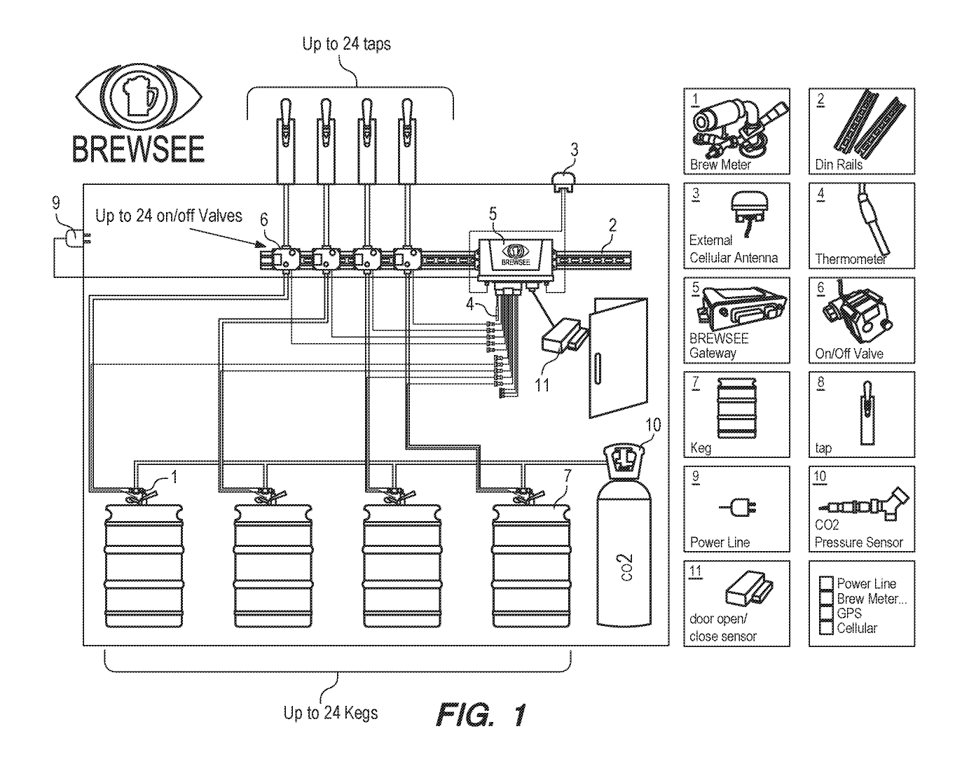

The configuration of the wireless keg management and monitoring system of the present invention is illustrated in FIG. 1, wherein the wireless keg management and monitoring system is comprised of a meter 1, a wireless antenna 3, a thermometer 4, a data hub 5, and on/off valves 6. Specifically, the meter 1 connects to at least one keg 7 having a coupler at one end and connections to tubing at the opposite end. The tubing subsequently connects to an on/off valve 6 which is mounted to previously installed din rails 2. From the on/off valve 6 the tubing connects directly to at least one corresponding tap 8. The meter 1 further connects to the data hub 5 (i.e. BrewSee), in order to receive power as well as communicate data to the data hub 5. The data hub 5 is mounted to the din rails 2 and is further comprised of a 1 BitBus digital thermometer with variable temperature detection reporting 4 for measuring the ambient refrigeration temperature in a cooler, an antenna 3 having a cellular and a GPS signal, and a power line 9.

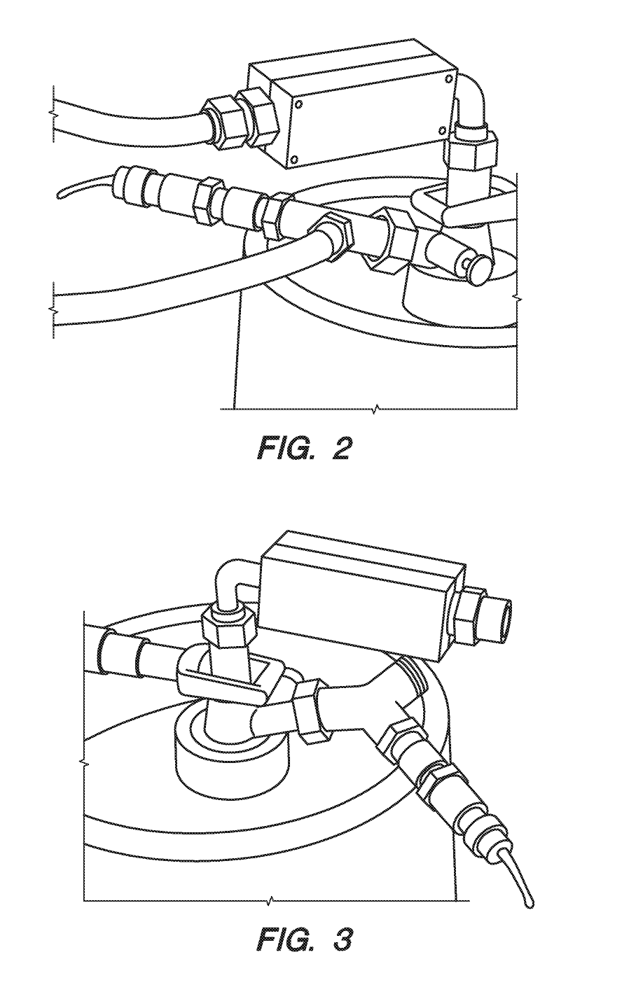

With regard to FIG. 2, shown is the meter 1 of the present invention installed on at least one keg using a standard keg coupler and not requiring any retrofitting or special connectors for the meter 1 to attach to a keg.

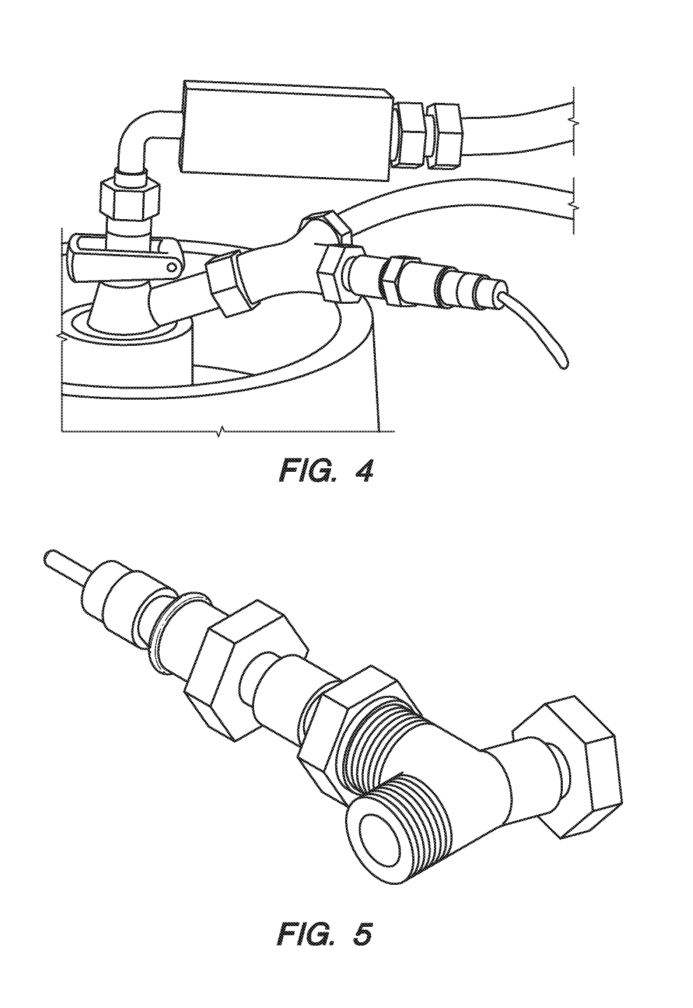

With regard to FIG. 3 and FIG. 4, shown are alternative views of the meter 1 of the present invention installed on at least one keg.

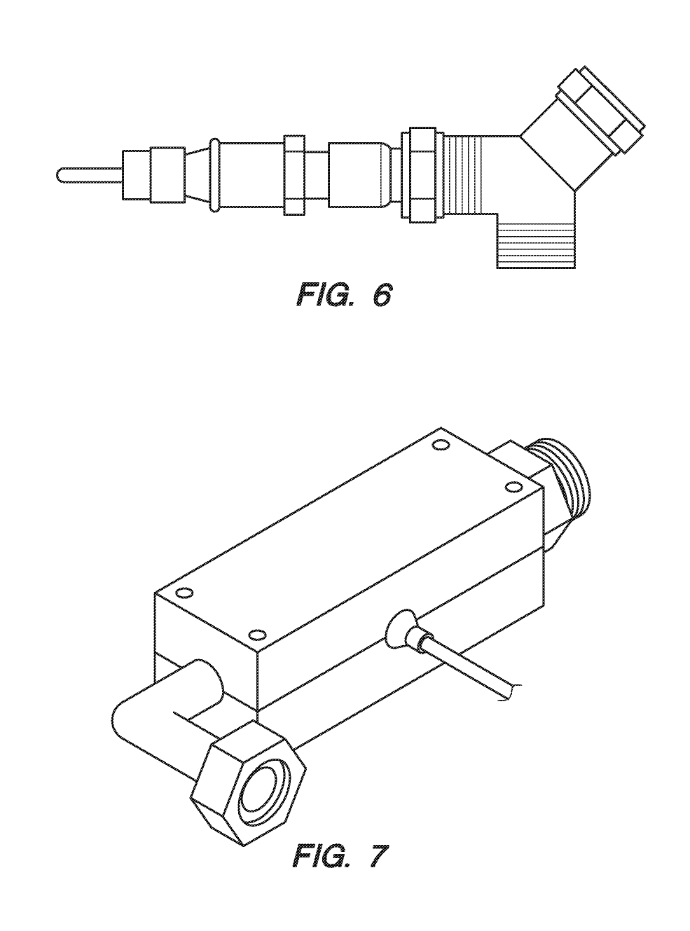

With regard to FIG. 5 and FIG. 6, shown are alternative views of the uninstalled pressure transducer coupler of the present invention which attaches to the keg at the point where a standard CO₂ line is connected. The CO₂ line is then connected to the keg with the pressure transducer coupler serving as an intermediate piece. In particular, the pressure transducer converts pressure into an analog electrical signal by the physical deformation of strain gages which are bonded into the diaphragm of the pressure transducer. Pressure applied to the pressure transducer produces a deflection of the diaphragm which introduces strain to the gages. The strain will produce an electrical resistance change proportional to the pressure.

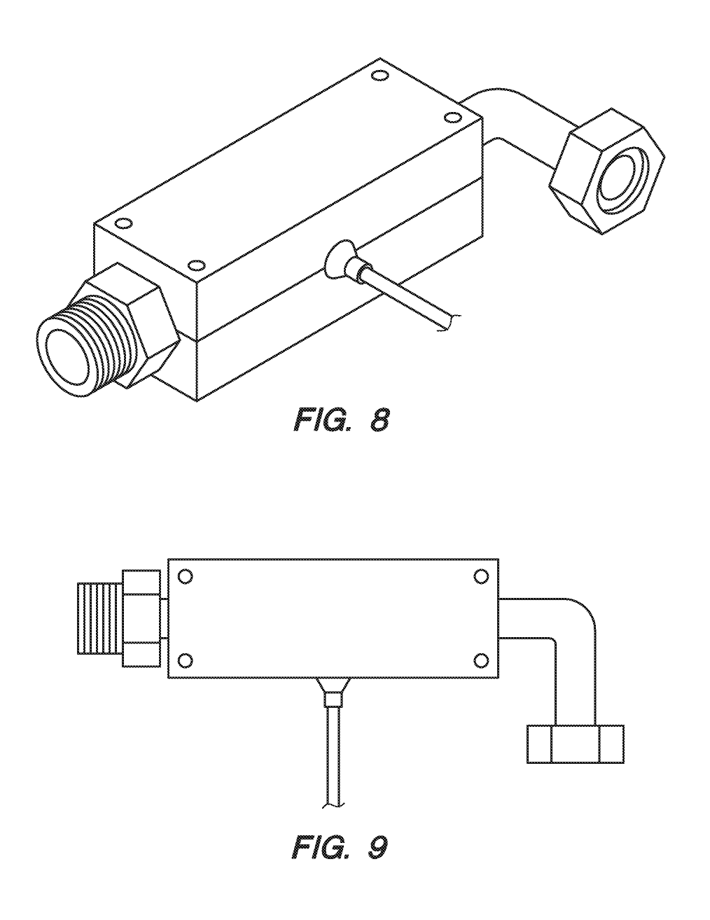

With regard to FIG. 7, FIG. 8 and FIG. 9, shown are alternative views of the uninstalled meter 1 of the present invention having a screw nut on one end and threading for a screw nut on the opposite end. The meter is further comprised of a flow meter (not shown) being positioned within the meter for measuring keg volume using pulses. In particular, the flow meter utilizes the Hall Effect wherein an integrated circuit device in the flow meter is activated by magnetic field reversals. The magnets in the impellers of the positive displacement flow meter trigger the latching circuit in the sensor, which in turn transmits a square-wave pulse to the connected data hub. As a result, the flow meter measures actual flow from the keg which in turn allows for total flow management on a per keg basis including but not limited to, per pour determination.

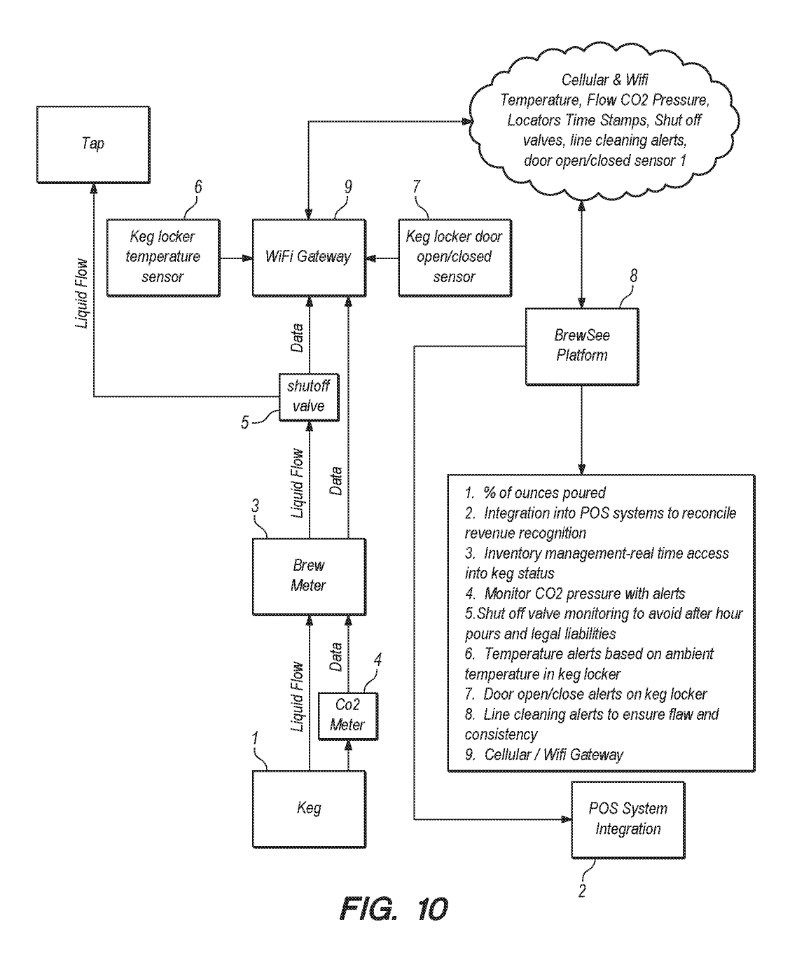

With regard to FIG. 10, shown is a schematic of the wireless keg management and monitoring system of the present invention. Beginning with a keg 7, beer flows from the keg 7 through the meter 1 while simultaneously a pressure transducer 12 measures the level of CO₂ supplied to the keg 7 from an independent source. Data from the pressure transducer 12 is communicated to the meter 1 and continues until it reaches the data hub 5. Beer flows through the meter 1 and subsequently through an on/off valve 6 before reaching the tap 8. Data collected by the meter 1 is also communicated to the data hub 5 whereby the data from the meter 1 and the CO₂ pressure transducer 12 is transmitted to the cloud 13 by cellular and/or Wi-Fi signal. From the cloud 13, data is transmitted to the BrewSee platform 14 comprised of proprietary software for organizing and distributing the data collected by the system. The wireless keg management and monitoring system may collect data such as, but not limited to, refrigeration temperature, total flow, CO₂ pressure, location and time of data collection. The BrewSee platform 14 is also capable of being programmed to provide instructions to the system to control the on/off valve 6 according to customizable parameters.

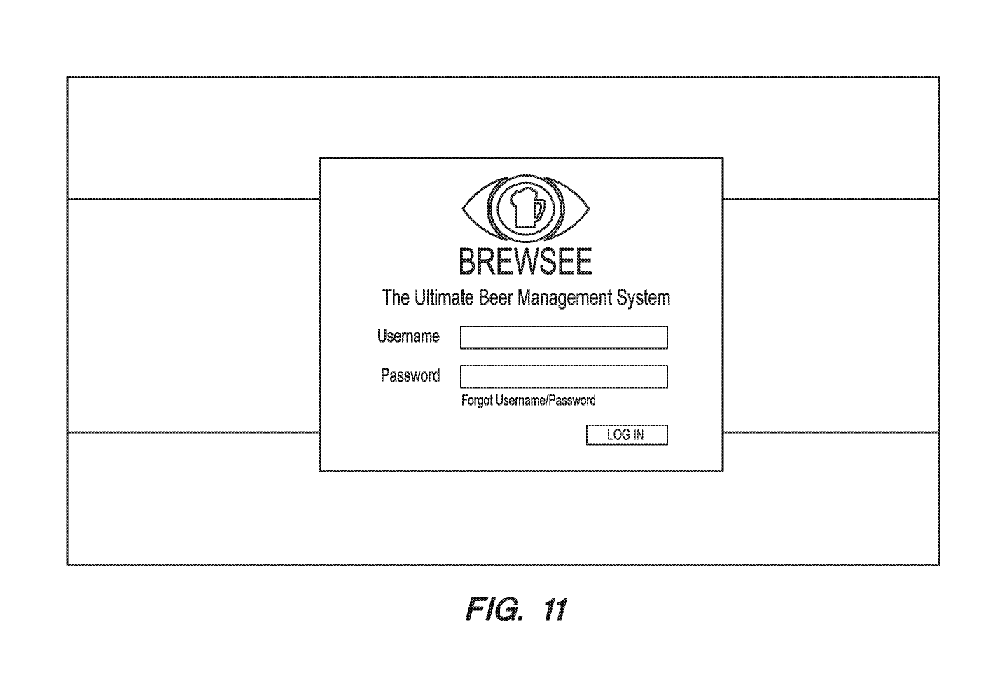

With regard to FIG. 11, shown is the login page from the user platform of the present invention. Users must sign up to create a profile and enter login credentials to access their keg information.

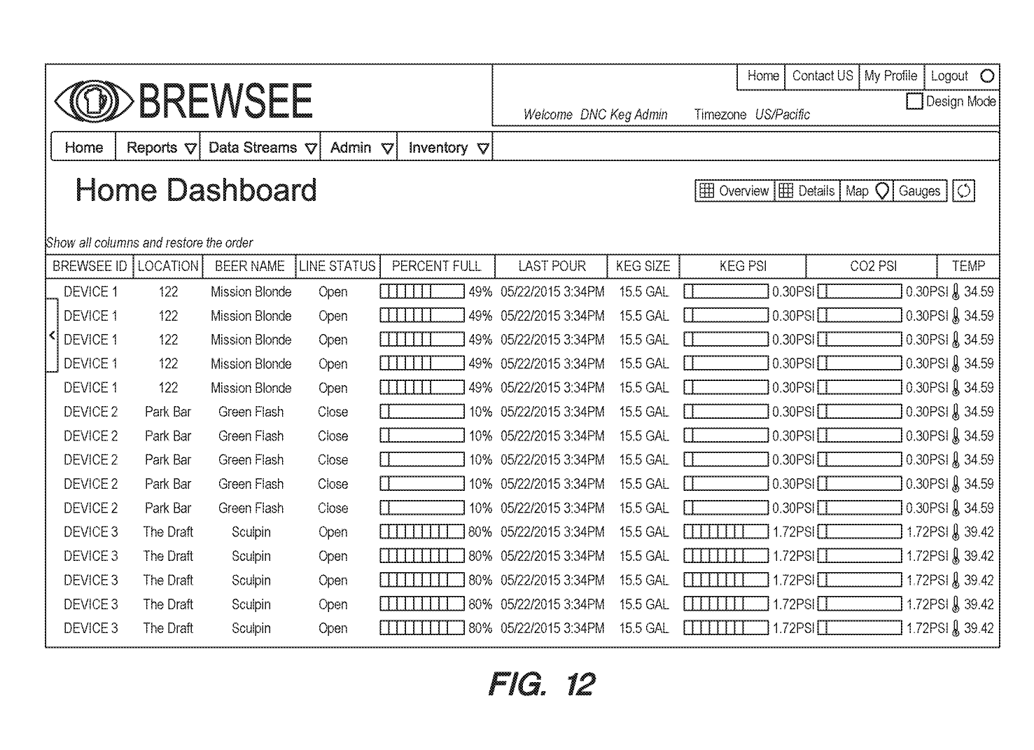

With regard to FIG. 12, shown is the home dashboard page from the user platform of the present invention. Once logged in, users are directed to the home dashboard page where keg information is organized. Information available on the home dashboard includes, but is not limited to, Brewsee ID, location, beer name, line status, percent full, last pour, keg size, keg psi, CO₂ psi and refrigeration temperature.

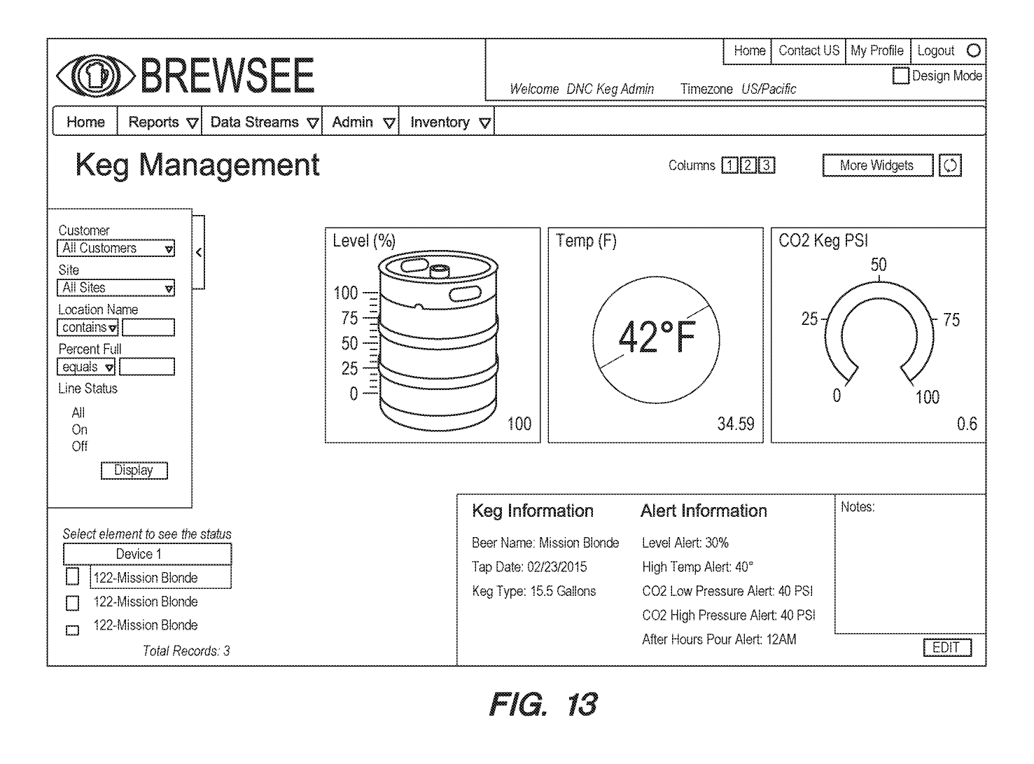

With regard to FIG. 13, shown is the keg management page from the user platform of the present invention. Users can select a Brewsee ID in order to access the keg management page wherein in depth keg information is provided.

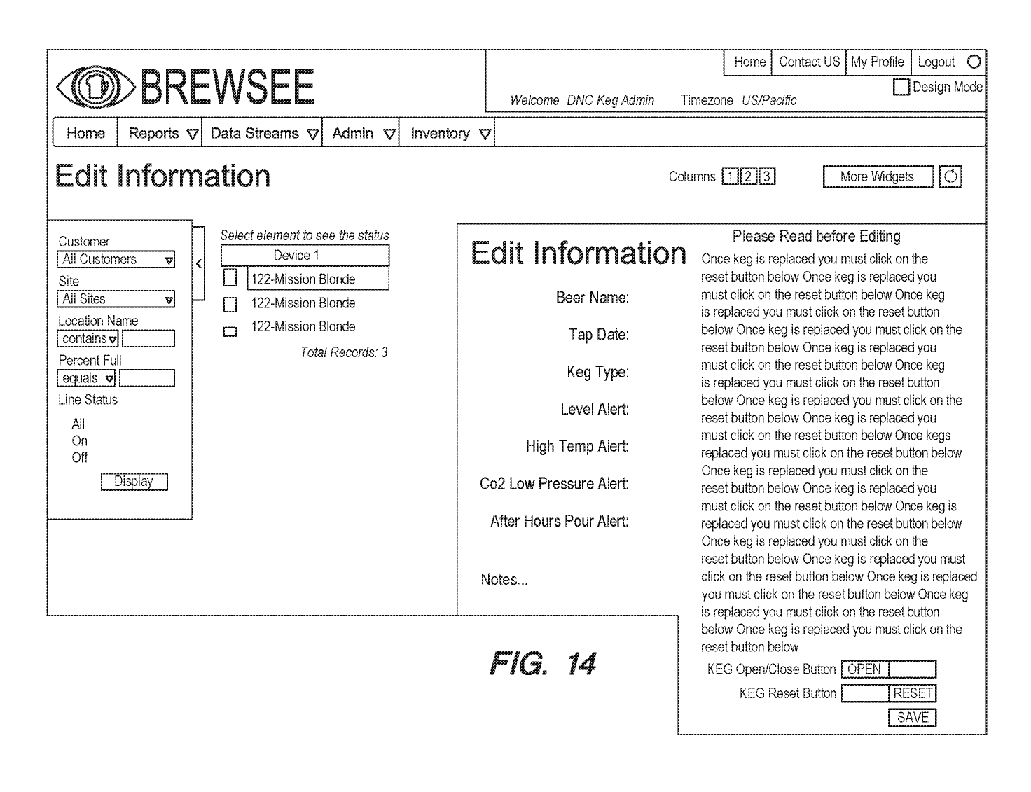

With regard to FIG. 14, shown is the data entry page from the user platform of the present invention. Users can select the edit button on the keg management page in order to edit keg information. Users have the option of opening, closing and resetting kegs. Customized information and alerts can be set including, but not limited to, beer name, tap date, keg type, level alert, high refrigeration temperature alert, CO₂ low pressure alert, and alter hours pour alert.

The keg management system monitors and measures the flow of beer from at least one keg to a tap, reports the CO₂ pressure from the at least one keg, refrigeration temperature of the keg storage cooler and controls a shut of valve to prevent unauthorized usage of the at least one keg to limit after hours distribution of beer and the liability associated with it. The keg management system is also equipped with a magnetic door open/close sensor to record the access to the keg storage area. The keg management system operates on either the public cellular network, or WiFi, and provides real-time data analytics reporting and recording the volume of beer flowing from the keg to the tap, while monitoring statistics of every keg system parameter, i.e. CO₂, refrigeration temperature and automatic shut off valves based on end-user defined parameters.

The keg monitoring system is capable of providing alerts to users while monitoring up to 25 kegs however it is contemplated that the system may monitor an unlimited amount of kegs on a single solution. Two key features of the monitoring system is the ability to remotely control shut off valves, prohibiting after hour pours and the liability and lost profit associated with it and pre-calculated line cleaning alerts to ensure the cleanliness of the beverage dispensing system. The auto generated prompts to clean the system improves the taste and quality of the beer. Regular maintenance is required as a preventative measure against mold, bacteria and yeast build up within the keg lines.

The keg monitoring system may further include RFID and/or Bluetooth temperature tags for kegs in order to monitor their temperature and location as they move from the distributor to the bar or restaurant where they will be installed. There may also be an incorporated Point of Sale reconciliation feature and game style feature allowing customers to interact with the system to see what beers are available, how much is left in the keg and how long the keg has been tapped. The portal may also give owner users the ability to run promotions to finish a particular keg and tape a new one when a current keg is close to being empty.

In the first embodiment, the present invention provides a wireless keg management and monitoring system wherein the system is comprised of at least one meter, a wireless antenna, a thermometer, a data hub, and an on/of valve. In a preferred embodiment, the on/off valve may be programmed to automatically close preventing unauthorized pours and/or after hour pours by staff.

In another embodiment, the present invention provides a wireless keg management and monitoring system wherein the meter is further comprised of a flow meter contained within the housing, the meter further having a coupler at one end for connecting to a keg and a coupler at the opposite end for connecting tubing.

In still another embodiment, the present invention provides a wireless keg management and monitoring system wherein the meter is capable of providing real time monitoring of the temperature including variable refrigeration temperature differential detection reporting, total flow, CO₂ pressure, location and time stamp of at least one keg which is connected to the system.

In another embodiment, the present invention provides a wireless keg management and monitoring system wherein the wireless antennae enables a data hub to communicate data via cellular network and provide a GPS signal providing the location of the data hub.

In yet another embodiment, the present invention provides a wireless keg management and monitoring system wherein the data hub is capable of receiving data from at least one meter and up to five meters simultaneously while being capable of controlling at least one on/off valve but up to five on/of valves simultaneously.

In a further embodiment, the present invention provides a wireless keg management and monitoring system wherein a data hub is programmable through a user platform for customizable control of at least one meter and/or on/off valve.

In a further still embodiment, the present invention provides a wireless keg management and monitoring system wherein the user platform allows the user to view and organize data received from meters at various locations in real time simultaneously.

In another embodiment, the present invention provides a wireless keg management and monitoring system wherein the user platform is compatible with a variety of devices including, but not limited to, computers, iPads, tablets, and smart phones.

The foregoing detailed description is not to be taken in a limiting sense, and the scope of the present invention is defined by the appended claims and their equivalents. Although several embodiments have been presented, one skilled in the art will appreciate that various modifications are possible. Such variations will not materially alter the nature of the invention. Many embodiments may be conceived and may not achieve all the advantages of some embodiments, particularly preferred embodiments, yet the absence of a particular advantage shall not be construed to necessarily mean that such an embodiment is outside the scope of the present invention.

1. A wireless keg management and monitoring system, the system comprising:
at least one meter having a coupler on each end;
at least one external combination wireless and GPS antenna;
a data hub;
at least one thermometer;
at least one on/off valve;
at least one pressure sensor; and
a door open/closed sensor, wherein the system provides real-time monitoring of at least one keg.

2. The wireless keg management and monitoring system of claim 1, wherein the at least one meter is connected to the at least one keg.

3. The wireless keg management and monitoring system of claim 2, wherein the at least one meter is a flow meter for measuring the total flow of beer from the at least one keg.

4. The wireless keg management and monitoring system of claim 1, wherein the at least one external antenna transmits a signal selected from the group consisting of cellular, WiFi and RFID.

5. The wireless keg management and monitoring system of claim 1, wherein the data hub is controlled by a programmable user platform.

6. The wireless keg management and monitoring system of claim 1, wherein the at least one pressure sensor is a CO₂ sensor which connects to the at least one keg at the point of connection of a standard CO₂ line.

7. The wireless keg management and monitoring system of claim 1, wherein the thermometer may measure ambient refrigeration temperature or keg temperature.

8. The wireless keg management and monitoring system of claim 1, wherein the data hub collects data from the system and transmits the data to the programmable user platform, the user platform being capable of controlling at least one meter and at least one on/off valve remotely and automatically according to preprogrammed parameters.

9. The wireless keg management and monitoring system of claim 8, wherein the user platform is capable of sending alert messages to a user if data points fall outside of preprogrammed parameters.

10. A method of monitoring and managing a keg, the method comprising installing a wireless keg management and monitoring system in a commercial establishment having beverage dispensing units, wherein the system comprises:
at least one meter having a coupler on each end;
at least one external combination wireless and GPS antenna;
a data hub;
at least one thermometer;
at least one on/off valve;
at least one pressure sensor; and
a door open/closed sensor, wherein the system provides real-time monitoring of at least one keg.

11. The method of claim 10, wherein the at least one meter is connected to the at least one keg.

12. The method of claim 11, wherein the at least one meter is a flow meter for measuring the total flow of beer from the at least one keg.

13. The method of claim 10, wherein the at least one external antenna transmits a signal selected from the group consisting of cellular, WiFi and RFID.

14. The method of claim 10, wherein the data hub is controlled by a programmable user platform.

15. The method of claim 10, wherein the at least one pressure sensor is a CO₂ sensor which connects to the at least one keg at the point of connection of a standard CO₂ line.

16. The method of claim 10, wherein the thermometer may measure ambient refrigeration temperature or keg temperature.

17. The method of claim 10, wherein the data hub collects data from the system and transmits the data to the programmable user platform, the user platform being capable of controlling at least one meter and at least one on/off valve remotely and automatically according to preprogrammed parameters.

18. The method of claim 17, wherein the user platform is capable of sending alert messages to a user if data points fall outside of preprogrammed parameters.
